(19) United States
(12) Patent Application Publication
(10) Pub. No.: US 2010/0055020 A1
(43) Pub. Date: Mar. 4, 2010

(54) Apparatus and Method for a Crucible Design and Tipping Mechanism for Silicon Casting

(75) Inventors: James A. Cliber, Emmitsburg, MD (US); Nathan G. Stoddard, Gettysburg, PA (US)

Correspondence Address: CAROL WILSON;BP AMERICA INC., MAIL CODE 5 EAST, 4101 WINFIELD ROAD, WARRENVILLE, IL, 60555, US

(73) Assignee: BP Corporation North America Inc, Warrenville, IL (US)

(21) Appl. No.: 12/548,110

(22) Filed: Aug. 26, 2009

Related U.S. Application Data
(60) Provisional application No. 61/121,241, filed on Dec. 10, 2008.
(60) Provisional application No. 61/092,186, filed on Aug. 27, 2008.

(51) Int. Cl. C01B 33/02; B28B 1/14; B29C 39/00; B22D 7/06

(52) U.S. Cl. 423/348; 264/299; 249/174

(57) ABSTRACT

This invention relates to an apparatus and a method of a crucible design and a tipping mechanism used to cast silicon. The crucible of this invention produces high purity silicon for solar cells and/or solar modules, such as by improving quality and/or reducing impurities in the cast silicon. As impurities concentrate in an uncrystallized portion of the silicon, a portion of the remaining molten silicon is poured or decanted from the main portion of the crucible to a second portion of the crucible.

This application claims the benefit of U.S. Provisional Application No. 61/121,241, filed Dec. 10, 2008 and U.S. Provisional Patent Application No. 61/092,186 filed Aug. 27, 2008 the entirety of both are expressly incorporated herein by reference.

### BACKGROUND

1. Technical Field

This invention relates to an apparatus and a method of use for a crucible design and a tipping mechanism used to cast silicon.

2. Discussion of Related Art

Photovoltaic cells convert light into electric current. One of the most important features of a photovoltaic cell is its efficiency in converting light energy into electrical energy. Although photovoltaic cells can be fabricated from a variety of semiconductor materials, silicon is generally used because it is readily available at reasonable cost, and because it has a suitable balance of electrical, physical, and chemical properties for use in fabricating photovoltaic cells.

In a known procedure for the manufacture of photovoltaic cells, silicon feedstock is doped with a dopant having either a positive or negative conductivity type, melted, and then crystallized by pulling crystallized silicon out of a melt zone into ingots of monocrystalline silicon (via the Czochralski (CZ) or float zone (FZ) methods). For a FZ process, solid material is fed through a melting zone, melted upon entry into one side of the melting zone, and re-solidified on the other side of the melting zone, generally by contacting a seed crystal.

Recently, a new technique for producing monocrystalline or geometric multicrystalline material in a crucible solidification process (i.e. a cast-in-place or casting process) has been invented, as disclosed in U.S. patent application Ser. Nos. 11/624,365 and 11/624,411, and published in U.S. Patent Application Publication Nos.: 20070169684A1 and 20070169685A1, filed Jan. 18, 2007. Casting processes for preparing multicrystalline silicon ingots are known in the art of photovoltaic technology. Briefly, in such processes, molten silicon is contained in a crucible, such as a quartz crucible, and is cooled in a controlled manner to permit the crystallization of the silicon contained therein. The block of cast crystalline silicon that results is generally cut into bricks having a cross-section that is the same as or close to the size of the wafer to be used for manufacturing a photovoltaic cell, and the bricks are sawn or otherwise cut into such wafers. Multicrystalline silicon produced in such manner is composed of crystal grains where, within the wafers made therefrom, the orientation of the grains relative to one another is effectively random. Monocrystalline or geometric multicrystalline silicon has specifically chosen grain orientations and (in the latter case) grain boundaries, and can be formed by the new casting techniques disclosed in the above-mentioned patent applications by melting in a crucible the solid silicon into liquid silicon in contact with a large seed layer that remains partially solid during the process and through which heat is extracted during solidification, all while remaining in the same crucible. As used herein, the term ‘seed layer’ refers to a crystal or group of crystals with desired crystal orientations that form a continuous layer. They can be made to conform to one side of a crucible for casting purposes.

In order to produce high quality cast ingots, several conditions should be met. Firstly, as much of the ingot as possible should have the desired crystallinity. If the ingot is intended to be monocrystalline, then the entire usable portion of the ingot should be monocrystalline, and likewise for geometric multicrystalline material. Secondly, the silicon should contain as few imperfections as possible. Imperfections can include individual impurities, agglomerates of impurities, intrinsic lattice defects and structural defects in the silicon lattice, such as dislocations and stacking faults. Many of these imperfections can cause a fast recombination of electrical charge carriers in a functioning photovoltaic cell made from crystalline silicon. This can cause a decrease in the efficiency of the cell.

Many years of development have resulted in a minimal amount of imperfections in well-grown CZ and FZ silicon. Dislocation free single crystals can be achieved by first growing a thin neck where all dislocations incorporated at the seed are allowed to grow out. The incorporation of inclusions and secondary phases (for example silicon nitride, silicon oxide or silicon carbide particles) is avoided by maintaining a counter-rotation of the seed crystal relative to the melt. Oxygen incorporation can be lessened using magnetic CZ techniques and minimized using FZ techniques as is known in the industry. Metallic impurities are generally minimized by being segregated to the tang end or left in the potscrap after the boule is brought to an end.

However, even with the above improvements in the CZ and FZ processes, there is a need and a desire to produce high purity crystalline silicon that is less expensive on a per volume basis, needs less capital investment in facilities, needs less space, and/or less complexity to operate, than known CZ and FZ processes. There is also a need and a desire to improve the quality of the cast silicon and/or reduce impurities, such as to remove the last 1-2 percent of liquid before it solidifies.

### SUMMARY

This invention relates to an apparatus and a method for a crucible design and a tipping mechanism used to cast silicon. The crucible of this invention can be used to produce high purity silicon, such as by improving quality and/or reducing impurities in the cast silicon ingot. Desirably, as impurities concentrate in an uncrystallized portion of the silicon, a portion of the remaining molten silicon with concentrated impurities can be poured or decanted from the main portion of the crucible, such as the impurities cannot diffuse into a cast silicon ingot.

According to a first embodiment, this invention relates to a vessel for casting high purity silicon. The vessel includes a bottom, one or more sides rising from the bottom and forming a first volume. The vessel also includes a second volume formed by an upper portion of one of the one or more sides and fluidly connected to the first volume.

According to a second embodiment, this invention relates to an apparatus for casting high purity silicon. The apparatus includes a vessel having a first volume and a second volume. The second volume fluidly connects with an upper portion of the first volume. The apparatus also includes a tipping mechanism, such as to elevate or tip a portion of the vessel.

According to a third embodiment, this invention relates to a method for casting high purity silicon. The method includes the step of providing a feedstock in a first volume of a vessel, and the step of solidifying at least a portion of the feedstock by extracting heat through a bottom or at least one side of the first volume. The method also includes the step of decanting or pouring a portion of the feedstock into a second volume.

According to a fourth embodiment, this invention includes a high purity silicon ingot made by the method and/or apparatus described above.

### BRIEF DESCRIPTION OF THE DRAWINGS

The accompanying drawings, which are incorporated in and constitute a part of this specification, illustrate embodiments of the invention and, together with the description, serve to explain the features, advantages, and principles of the invention. In the drawings:

FIG. 1A illustrates a side sectional view of a vessel, according to one embodiment;

FIG. 1B illustrates a side sectional view of a decanted vessel, according to one embodiment;

FIG. 2A illustrates a side sectional view of a casting station, according to one embodiment;

FIG. 2B illustrates a side sectional view of a tipped casting station, according to one embodiment;

FIG. 2C illustrates a side sectional view of a tipped casting station, according to one embodiment;

FIG. 3 illustrates a side sectional view of a vessel, according to one embodiment;

FIG. 4A illustrates an isometric view of a vessel, according to one embodiment;

FIG. 4B illustrates a top view of a vessel, according to one embodiment;

FIG. 4C illustrates a side sectional view of a vessel, according to one embodiment; and

FIG. 4D illustrates a side sectional view of a vessel perpendicular to the view of FIG. 4C, according to one embodiment.

### DETAILED DESCRIPTION

According to one embodiment, this invention addresses the relatively contaminated liquid that is the last to solidify during the casting growth process. Most elements and/or compounds have a very low solubility in solid silicon, due to the nature of the strong covalent bonding between silicon atoms. The liquid solubility is generally quite high, and limited only by the formation of secondary phases at sufficient concentrations. As a result, steady crystallization of silicon will result in a high degree of segregation for most impurities. The impurities will preferentially remain in the liquid portion of the material, but as solidification proceeds to higher fractions of the total silicon, the liquid will become more and more concentrated with impurities. The ratio of impurities incorporated in the solid to the concentration on the liquid side of the interface will be a constant. This behavior tends to break down if solidification proceeds too rapidly or if dendritic crystallization occurs. Because of the segregation of impurities towards the liquid phase during solidification or crystallization, the remaining liquid can become increasingly concentrated with impurities. Once the last part of the ingot solidifies, these impurities will finally get incorporated into the solid at high concentrations. In normal casting, the last to solidify is the very top of the ingot. Because of high temperatures and high concentration gradients, the impurities will quickly start diffusing backwards or downwards (re-contaminating) into the ingot. The resulting ingot may include a higher metals content in the ingot and an unusable portion, such as up to about 2 centimeters thick at the top of the ingot (up to 10 percent by volume).

This invention can be incorporated as a new casting station design and/or a possible retrofit to an existing casting station. This invention can increase the yield of good usable silicon in an ingot (reduce scrap), according to one embodiment. Additionally, this invention can provide an improvement of electrical efficiency in silicon wafers that come from a top portion of the ingot. The silicon wafers of the ingot top portion can yield solar cells with an efficiency of greater than about 14 percent and desirably greater than about 17 percent.

Desirably, this invention includes the use of a crucible with a built-in partition for holding a portion of spill-over silicon, such as a compartment for partitioning or separating the crucible into two volumes or more. Along one side of the crucible, a partial barrier separates the main volume of the crucible from a smaller spill-over volume or region. The spill-over region can be initially empty. The crucible design could be cast with slip-casting methods and/or other suitable methods or techniques.

The crucible could be used in two ways. In a stationary embodiment, the natural expansion of the solid silicon lifts the liquid silicon over the barrier edge to drain the remaining liquid portion, such as by use of surface tension and/or gravity. In the alternative, a dynamic embodiment includes a tipping mechanism, such as where the crucible could be tipped slightly once the solidification nears completion. The tipping may change a course of the growth process. Desirably, the solidification may proceed until less than about 5.0 centimeters, and desirably less than about 1.0 centimeter of liquid remains on top of the solid ingot, resulting in a volume fraction of the silicon in the crucible of about 10 percent to about 1 percent.

In either case, it may be desirable to maintain a flat melt solid interface, such as is formed by a casting station with heaters primarily located over the crucible and fewer or no heaters located on the sides. In the alternative, the heaters can be located or disposed on a top, a bottom, sides, and/or any other suitable location or combination of locations.

According to one embodiment, this invention includes a tipping mechanism, such as to form a hydraulic casting station. In order to achieve the tipping of the dynamic embodiment, it may be desirable to lift and/or lower one leg, one side, and/or a portion of the casting station, such as by a device located outside the hot zone (thereby eliminating the need for actuating devices functioning at elevated temperatures). This design can allow the actuation mechanisms or devices to operate in ambient conditions, such as were the moving parts remain outside the insulation of the furnace.

The overall displacement of the tipping mechanism or hydraulic leg can be about 2 centimeters to about 5 centimeters, and/or any other suitable distance, such as to decant a desired portion of molten silicon. Desirably, the tilt phase or position would only be held or used for a few moments to a couple of minutes, such as less than about 2 minutes, less than about 1 minute, and/or any other suitable duration. In order to prevent flash-freezing during the tipping action, it may be necessary to increase the heater power during this time period.

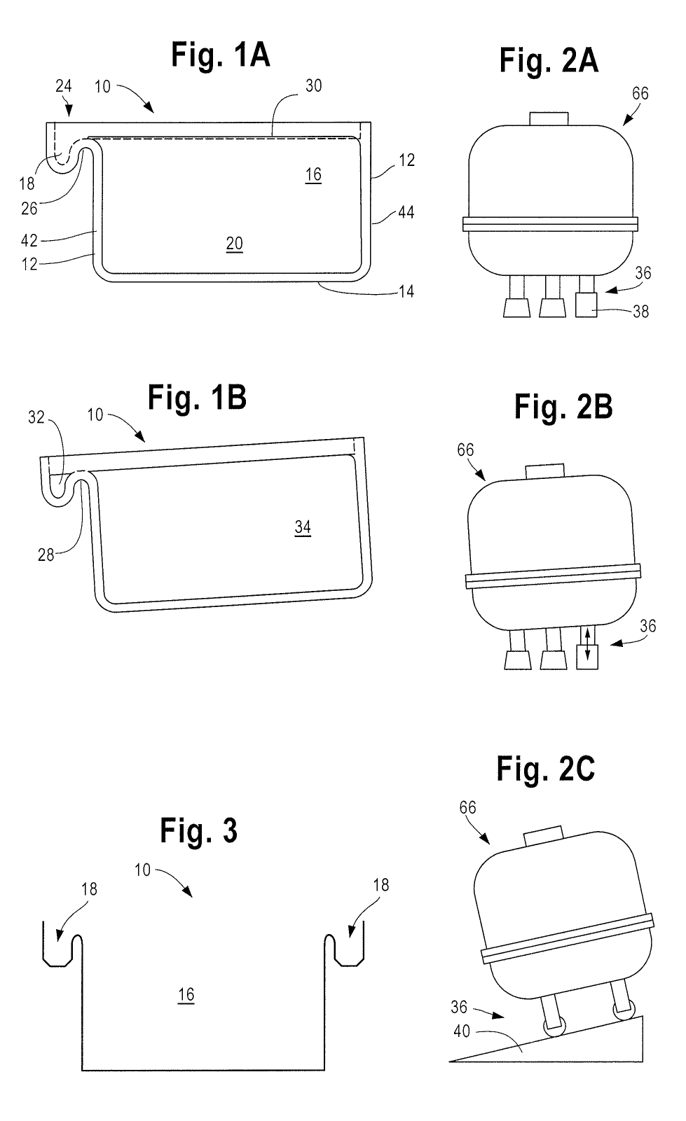

FIG. 1A illustrates a side sectional view of a vessel 10, according to one embodiment. The vessel 10 includes sides 12 and bottom 14 to form a first volume 16. A second volume 18 is in fluid communication with the first volume 16. The first volume 16 contains and/or holds a feedstock 20, such as silicon. The second volume 18 includes a trough-like shape 24 and can be separated or segregated from the first volume 16 by a spillway 26. During solidification a molten layer 30 forms on top of the solid as the melt-solid interface or solidification front advances up from the bottom 14. Desirably, the sides 12 of the vessel 10 include a first height 42 and a second height 44.

FIG. 1B illustrates a side sectional view of a vessel 10 that has been decanted or tipped, according to one embodiment. The vessel 10 contains an ingot 34 in the first volume and molten feedstock 32 in the second volume. A dam 28 can separate the first volume from the second volume.

FIG. 2A illustrates a side sectional view of a casting station 66, according to one embodiment. The casting station includes a tipping mechanism 36, such as a hydraulic leg 38 where a mechanism drives an actuator. This mechanism could be any suitable device or apparatus, such as a hydraulic mechanism, a screw drive, a chain drive, a linear actuator, and/or the like. The hydraulic leg 38 may operate in combination with other stationary legs and/or pivoting legs. FIG. 2B illustrates a side sectional view of a casting station 66 that has been tipped, according to one embodiment. The tipping mechanism 36 is in an actuated or extended position. FIG. 2C also illustrates a side sectional view of a casting station 66 that has been tipped, according to one embodiment. The tipping mechanism 36 includes a sloped surface 40, such as where the casting station 66 is rolled on wheels or castors up the ramp or slope. Desirably, the angle of tipping should be kept at a minimum to achieve the liquid removal in order to minimize stresses on the casting station.

FIG. 3 illustrates a side sectional view of a vessel 10, according to one embodiment. The first volume 16 may be in fluid communication with two or more second volumes 18, such as to allow tipping in two directions.

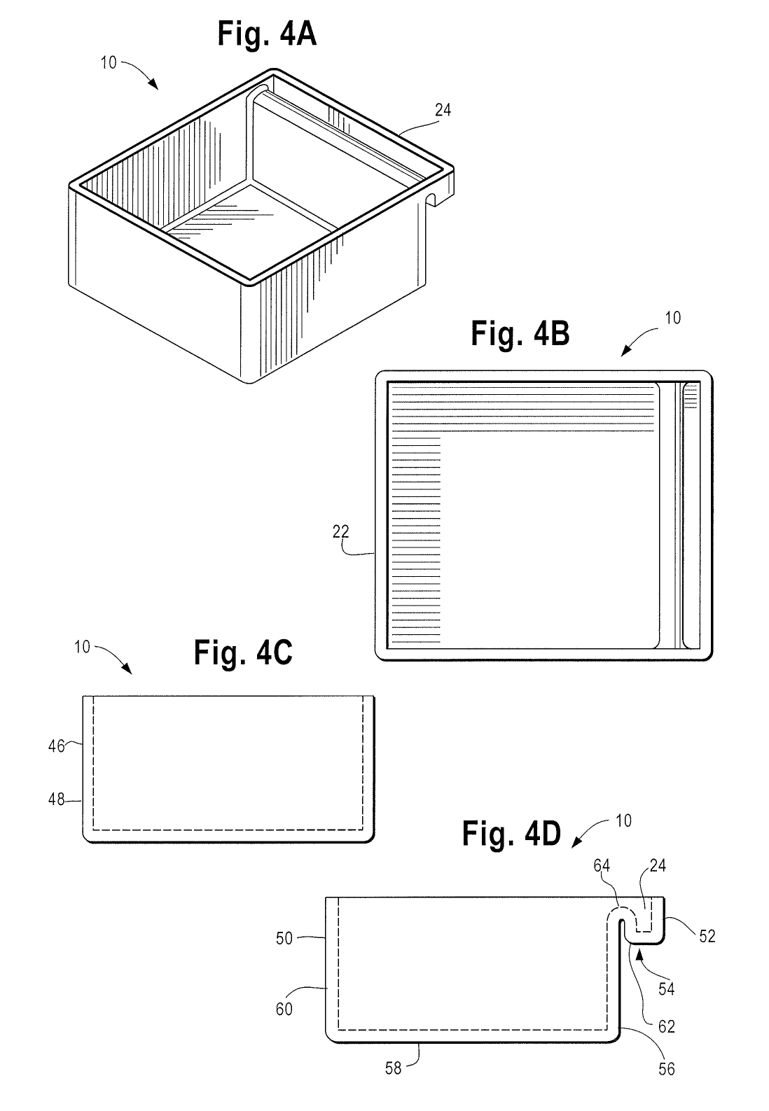

FIG. 4A illustrates an isometric view of a vessel 10, according to one embodiment. The vessel includes a trough-like shape 24 extending along a portion of an upper perimeter of the vessel 10. FIG. 4B illustrates a top view of a vessel 10, according to one embodiment. The vessel 10 includes a square shape 22. FIG. 4C illustrates a side sectional view of a vessel 10, according to one embodiment. The vessel 10 includes a first cross section 46, such as with a generally U-shape cross section 48.

FIG. 4D illustrates a side sectional view of a vessel 10 perpendicular to the view of FIG. 4C, according to one embodiment. The vessel 10 includes a second cross section 50. The second cross section 50 includes, from generally right to left and in connected order, a first generally vertical segment 52, a generally S-shape segment 54, a second generally vertical 56, a first generally horizontal segment 58, a third generally vertical segment 60, a first radius 62, and a second radius 64.

In the embodiments pictured, the decanting region is shown as being contained and continuous with the crucible, however it is conceivable that other geometries could be employed, such as more open schemes where the silicon flows out of the crucible and down to a sand pit or other containment zone near the bottom of the crucible. From an operability standpoint and to minimize risk to the hot zone components, it is believed that the pictured embodiment may be preferable.

Moreover, although casting of silicon has been described herein, other semiconductor materials and nonmetallic crystalline materials may be cast without departing from the scope and spirit of the invention. For example, the inventors have contemplated casting of other materials consistent with embodiments of the invention, such as germanium, gallium arsenide, silicon germanium, aluminum oxide (including its single crystal form of sapphire), gallium nitride, zinc oxide, zinc sulfide, gallium indium arsenide, indium antimonide, germanium, yttrium barium oxides, lanthanide oxides, magnesium oxide, calcium oxide, and other semiconductors, oxides, and intermetallics with a liquid phase. In addition, a number of other group III-V or group II-VI materials, as well as metals and alloys, could be cast according to embodiments of the present invention.

Cast silicon includes multicrystalline silicon, near multicrystalline silicon, geometric multicrystalline silicon, and/or monocrystalline silicon. Multicrystalline silicon refers to crystalline silicon having about a centimeter scale grain size distribution, with multiple randomly oriented crystals located within a body of multicrystalline silicon.

Geometric multicrystalline silicon or geometrically ordered multicrystalline silicon refers to crystalline silicon having a nonrandom ordered centimeter scale grain size distribution, with multiple ordered crystals located within a body of multicrystalline silicon. The geometric multicrystalline silicon may include grains typically having an average about 0.5 centimeters to about 5 centimeters in size and a grain orientation within a body of geometric multicrystalline silicon can be controlled according to predetermined orientations, such as using a combination of suitable seed crystals.

Polycrystalline silicon refers to crystalline silicon with micrometer to millimeter scale grain size and multiple grain orientations located within a given body of crystalline silicon. Polycrystalline silicon may include grains typically having an average of about submicron to about micron in size (e.g., individual grains are not visible to the naked eye) and a grain orientation distributed randomly throughout.

Monocrystalline silicon refers to crystalline silicon with very few grain boundaries since the material has generally and/or substantially the same crystal orientation. Monocrystalline material may be formed with one or more seed crystals, such as a piece of crystalline material brought in contact with liquid silicon during solidification to set the crystal growth. Near monocrystalline silicon refers to generally crystalline silicon with more grain boundaries than monocrystalline silicon but generally substantially fewer than multicrystalline silicon.

According to one embodiment, this invention may include a vessel for casting high purity silicon. The vessel may include a bottom, one or more sides rising from the bottom and forming a first volume. The vessel may include a second volume formed by an upper portion of one of the one or more sides and fluidly connecting to the first volume.

A vessel broadly includes a container for holding something, such as silicon feedstock. The vessel of this invention may include any suitable size and/or shape. The vessel may include one or more walls or sides, such as forming a generally circular shape, a generally elliptical shape, a generally triangular shape, a generally square shape, a generally rectangular shape, a generally hexagonal shape, a generally octagonal shape, and/or any other suitable shape or configuration.

The vessel may include any suitable number of walls, such as about 1, about 3, about 4, about 6, about 8, and/or the like. The walls may include straight and/or arcuate sections with any suitable angle or orientation, such as generally vertical, tapered inwards, tapered outwards and/or the like. Desirably, at least one of the one or more sides includes a first height that is less than a second height of the other walls, such as for combining with the second volume.

The vessel desirably, includes a bottom or a base, at least generally opposite a top or a lid. Generally, but not necessarily, the bottom includes a closed or solid design. Generally, but not necessarily, the top includes an open design or aperture. In the alternative, a lid and/or a cover may be removable from the vessel.

The vessel can include a first volume or a primary space of any suitable size, such as at least about 0.1 meters cubed, at least about 0.2 meters cubed, at least about 0.5 meters cubed, at least about 1 meter cubed, and/or the like. The first volume can be formed and/or bounded by the bottom and the walls, for example. The vessel can include any suitable diameter, length, width, and/or height. According to one embodiment, a ratio of height to length can be about 0.5:1.0, about 1.0:1.0, about 1.0:0.5 and/or any other suitable proportion.

The width of the first volume may include any suitable distance, such as about 20 centimeters to about 200 centimeters, about 50 centimeters to about 120 centimeters, about 50 centimeters to about 70 centimeters, about 67 centimeters, and/or the like. The height of the first volume may include any suitable distance, such as about 5 centimeters to about 100 centimeters, about 15 centimeters to about 50 centimeters, about 30 centimeters to about 35 centimeters, about 32.5 centimeters, and/or the like.

The width of the second volume may include any suitable distance, such as about 1 centimeter to about 15 centimeters, about 2 centimeters to about 8 centimeters, about 4 centimeters, and/or the like. The depth (height) of the second volume may include any suitable distance, such as about 4 centimeters to about 25 centimeters, about 8 centimeters to about 15 centimeters, about 10.4 centimeters, and/or the like.

The vessel can hold any suitable amount of liquid silicon and/or solid silicon, such as at least about 100 kilograms, at least about 200 kilograms, at least about 500 kilograms, at least about 750 kilograms, at least about 1000 kilograms, and/or the like. Desirably, the vessel can withstand exposure to elevated temperatures, such as at least about 500 degrees Celsius, at least about 750 degrees Celsius, at least about 1000 degrees Celsius, at least about 1250 degrees Celsius, at least about 1412 degrees Celsius (melting point of silicon), at least about 1500 degrees Celsius, and/or the like.

The vessel may sometimes be referred to as a crucible. A crucible broadly includes a vessel of refractory material or the like used for melting and calcining a substance that requires a high degree of heat.

The vessel may include or be made of any suitable material or substance, such as graphite, silicon carbide, silica, fused silica, silicon nitride, quartz, high temperature ceramic, aluminum oxide, aluminum nitride, aluminum silicate, boron nitride, zirconium phosphate, zirconium diboride, hafnium diboride, and/or the like. Desirably, the vessel may include materials of construction compatible with molten silicon, such as to not contaminate the feedstock and/or the product. The vessel may be a single-use design, such as generally fractures upon solidification of the ingot, or the vessel may be a multiple-use design, such as generally does not fracture upon solidification of the ingot. The vessel may include additional spouts, nozzles, instrument ports, vents, addition ports, doping devices, and/or the like to synergistically compliment the casting process.

Desirably, the vessel includes a monolithic and/or integral structure, construction, and/or fabrication, such as without joints and/or seams. In the alternative, the vessel includes multiple components or pieces assembled together, such as by mechanical fasteners.

The vessel may be used in any portion of the casting process, such as in a melting step, in a holding or accumulating step, in a purification step, and/or in a solidification step. According to one embodiment, the same vessel is used for all steps in a casting process. In the alternative, separate vessels may be used for the individual steps of the casting process, such as with the pouring or transferring of molten feedstock between the vessels.

The vessel can include a second volume or a secondary space of any suitable size and/or shape, such as a capacity of about 0.5 percent to about 10 percent of a capacity of the first volume, a capacity of about 1.0 percent to about 2.0 percent of a capacity of the first volume, and/or the like. The second volume may include about 0.005 meters cubed to about 0.08 meters cubed, about 0.02 meters cubed to about 0.04 meters cubed and/or the like.

The second volume may include any suitable arrangement of sides and/or components, such as formed by an upper or a top portion of one of the one or more sides. Desirably, but not necessarily, the second volume shares at least a portion of a side of the first volume. In the alternative the second volume includes separate sides from the first volume.

Fluidly connecting and/or in fluid communication broadly includes a liquid being able to flow, transport, and/or pass from a first location to a second location. Fluid connections may be made by any suitable manner, such as with channels, spill-ways, conduits, baffles, weirs, placing items in close proximity, and/or the like.

According to one embodiment, the second volume forms a generally trough-like shape generally along a length of the one of the one or more sides. The trough-like shape may generally be parallel to and/or aligned with a side of first volume and be disposed with respect to a top or near a top of the first volume.

A spillway broadly refers to a shape and/or form for a liquid to run over and/or around. Sometimes a spillway may include a dam which broadly refers to a barrier to check the flow of a liquid, such as unless or until the vessel is in the tipped or tilted position. Desirably, the spillway partially isolates the first volume and the second volume while providing fluid communication between the first volume and the second volume.

According to one embodiment, the vessel may include a first cross section having a generally U-shape, such as with two sides and a bottom when viewed from a side. The vessel may include a second cross section oriented generally perpendicular to the first cross section, such as turned about 90 degrees from the first cross section and viewed from an adjacent side.

The second cross section may include a first generally vertical segment with a length, a first end and a second end. The second cross section may include a generally S-shape segment rotated about 90 degrees in a generally left direction with a first end connecting to the second end of the first generally vertical segment and a second end. The second cross section may include a second generally vertical segment with a length of about 2 to about 7 times the length of the first generally vertical segment, a first end connecting to the second end of the generally S-shape segment and a second end.

The second cross section may include a first generally horizontal segment with a length of about 0.5 to about 5 times the length of the second generally vertical segment, a first end connecting to the second end of the second generally vertical segment and a second end. The second cross section may include a third generally vertical segment with a length of greater than about the length of the second generally vertical segment and less than about the sum of the length of the first generally vertical segment and the length of the second generally vertical segment.

Desirably, but not necessarily, a first radius of the generally S-shape segment includes about 1 to about 5 times a second radius of the generally S-shape segment.

According to one embodiment, this invention may include an apparatus for casting high purity silicon. The apparatus may include a vessel having a first volume and a second volume, wherein the second volume fluidly connects with an upper portion of the first volume, and a tipping mechanism.

The tilting, transferring, and/or tipping mechanism may include any suitable device, such as a hydraulic lift, a pneumatic lift, a mechanical lift, a screw, a scissor jack configuration and/or any other mechanism to raise and/or lower at least a portion of the vessel. According to one embodiment, the tipping mechanism includes a first generally fixed leg and a second adjustable leg to change a height of an end of the vessel, such as by lowering and/or raising one end. The legs may cradle and/or otherwise support the vessel and/or structure of the casting apparatus. In the alternative, the entire casting apparatus may be used to drain the remaining portion of molten silicon, such as by tilting and/or tipping the entire assembly. The tipping mechanism may include 2 units or devices, such as one on each leg of a side of the apparatus to raise and/or lower one end of the vessel.

According to one embodiment, the tipping mechanism raises or lowers one side of the apparatus. In the alternative, the tipping mechanism generally simultaneously raises a first end of the vessel and lowers a second end of the vessel. The tipping may include any suitable amount of travel and/or displacement, such as about 1 centimeter to about 10 centimeters, about 2.5 centimeters to about 5 centimeters, and/or the like. The tipping mechanism may include a hydraulic leg, a hydraulic cylinder, and/or the like. The tipping mechanism may include any suitable angle of tilt for the vessel, such as about 5 degrees to about 50 degrees, about 10 degrees to about 25 degrees, about 15 degrees, and/or the like.

In the alternative, the tipping mechanism utilizes a sloped surface, such as a ramp with about a 3 degree angle to about a 40 degree angle, about a 10 degree angle to about 25 degree angle, and/or the like.

The tipping mechanism may exclude the use of axial shafts to pivot about, such as a handle on a bucket. In the alternative the tipping mechanism may include axial shafts, such as to provide a point of rotation about which the tipping occurs. The axial shafts may be generally disposed in a center of a side, a middle of a side, and/or any other suitable location.

According to one embodiment the vessel may include at least one seed crystal disposed with respect to an interior surface of the vessel, such as on a bottom and/or one or more sides. Optionally, the seed crystal may include one generally uniform orientation and/or may include a tiled arrangement or differing orientations, for example.

According to one embodiment, the apparatus of this invention may include a vessel with more than one second volumes, such as a second volume on one side and another second volume on the opposite side. Having more than one second volume may allow a reduced tipping height in one direction. The multiple second volume configuration may include a tipping mechanism that can tip in more than one direction, such as first to the left and then to the right. Configurations with additional second volumes and additional tipping mechanisms are within the scope of this invention, such as 4 total. Having multiple second volumes may reduce a distance an impurity travels before being removed from the first volume and the silicon ingot product, such as to improve the likelihood of removal of the impurity.

As used herein the terms “having”, “comprising”, and “including” are open and inclusive expressions. Alternately, the term “consisting” is a closed and exclusive expression. Should any ambiguity exist in construing any term in the claims or the specification, the intent of the drafter is toward open and inclusive expressions.

Regarding an order, number, sequence and/or limit of repetition for steps in a method or process, the drafter intends no implied order, number, sequence and/or limit of repetition for the steps to the scope of the invention, unless explicitly provided.

According to one embodiment, this invention may include a method for casting high purity silicon. The method may include the step of providing a feedstock in a first volume of a vessel. The method may include the step of solidifying at least a portion of the feedstock by extracting heat through a bottom or at least one side of the first volume. The method may include the step of decanting a portion of the feedstock into a second volume.

The step of providing a feedstock in the first volume may include placing and/or loading a solid feedstock in the vessel, such as manually or with a suitable delivery device. The solid feedstock can then be melted within the vessel, such as by inductive or resistive heating devices. In the alternative, the providing may include pouring and/or flowing a generally molten feedstock into the vessel, such as liquid silicon. The molten feedstock may include a suitable amount of superheat above the melting point, such as at least about 10 degrees Celsius, at least about 20 degrees Celsius, and/or the like.

Solidifying broadly refers to turning a substance or material into a solid form, such as generally not a liquid or a gas. Desirably, the solidifying includes crystallization, such as generally a chemical element, a compound, and/or a mixture with a regularly repeating internal arrangement of atoms and external plane faces. The solidifying may form multicrystalline silicon, near multicrystalline silicon, geometric multicrystalline silicon, and/or monocrystalline silicon.

Generally solidification may occur by lowering and/or reducing an internal energy and/or enthalpy of a substance, such as to remove super heat and a heat of fusion from the liquid or molten state. Solidification may further include subcooling, such as below the freezing point of a material. Desirably, subcooling includes reaching ambient conditions, such as about 20 degrees Celsius.

Decanting broadly refers to pouring or drawing off a liquid without disturbing the sediment or the lower liquid and/or solid layers (ingot). Decanting may also include pouring from one vessel into another, pouring out, transferring, and/or unloading. Desirably, the decanting occurs and/or happens relatively slowly, such as to avoid sloshing and/or spilling of molten silicon which could present safety and/or operational issues. In the alternative, the decanting occurs with significant speed.

According to one embodiment, a rake or other suitable high temperature apparatus can be physically drawn across a top of the contents of the vessel, such as to assist in removing impurities.

According to one embodiment, the decanting removes a top or upper molten layer of feedstock with a higher concentration of impurities than a solidified portion of the feedstock, such as at least about 5 times the concentration of impurities in the initial feedstock, at least about 10 times the concentration of impurities in the initial feedstock, at least about 50 times the concentration of impurities in the initial feedstock, at least about 100 times the concentration of impurities in the initial feedstock, and/or the like.

The decanting may include any suitable volume of feedstock, such as transferring less than about 10 volume percent of the feedstock provided to the first volume to or into the second volume, less than about 5 volume percent of the feedstock provided to the first volume to or into the second volume, less than about 2 volume percent of the feedstock provided to the first volume to or into the second volume, and/or the like.

The decanting may include flowing the portion of the feedstock into the second volume based on expansion of the feedstock during solidification, such as without external actuation. In the alternative, the decanting may include flowing a portion of the feedstock with actuation of a tipping or tilting mechanism.

The method may also include the step of melting the feedstock in the first volume, such as with heaters as discussed above. According to one embodiment, this method excludes the step of rotating a portion of the apparatus and/or excludes the step of pulling the crystal. According to one embodiment, the invention may include placing one or more seed crystals and/or layers within the vessel. The method may include melting a portion of the seed crystal and orienting the solidifying feedstock with the seed crystal.

The method and/or ingot of this invention may include adding and/or adjusting any suitable dopant or counter dopant (concentration) to the silicon, such as phosphorous, boron, carbon, and/or the like. Dopants may desirably change the electrical properties of the silicon or semiconductor material.

According to one embodiment, this invention includes a high purity silicon ingot made by the apparatuses and/or the methods described above. The ingot may include primarily silicon selected from the group consisting of multicrystalline silicon, monocrystalline silicon, near monocrystalline silicon, geometric multicrystalline silicon, and/or the like. The ingot may further be substantially free from radially distributed defects, such as made without the use of rotational processes.

The ingot of this invention may include any suitable level of reduced impurities. Impurities broadly include carbon, silicon carbide, silicon nitride, oxygen, other metals, and/or substances which generally reduce an efficiency of a solar cell or a solar module. The ingot may include a carbon concentration of about 2×10¹⁶ atoms/centimeter cubed to about 5×10¹⁷ atoms/centimeter cubed, an oxygen concentration not exceeding 7×10¹⁷ atoms/centimeter cubed, and a nitrogen concentration of at least 1×10¹⁵ atoms/centimeter cubed.

It will be apparent to those skilled in the art that various modifications and variations can be made in the disclosed structures and methods without departing from the scope or spirit of the invention. Particularly, descriptions of any one embodiment can be freely combined with descriptions or other embodiments to result in combinations and/or variations of two or more elements or limitations. Other embodiments of the invention will be apparent to those skilled in the art from consideration of the specification and practice of the invention disclosed herein. It is intended that the specification be considered exemplary only, with a true scope and spirit of the invention being indicated by the following claims.

What is claimed is:

1. A vessel for casting high purity silicon, the vessel comprising:
a bottom;
one or more sides rising from the bottom and forming a first volume; and
a second volume formed by an upper portion of one of the one or more sides and fluidly connecting to the first volume.

2. The vessel of claim 1, wherein the vessel comprises fused silica.

3. The vessel of claim 1, wherein the one or more sides comprise four sides having a generally square or rectangular shape.

4. The vessel of claim 1, wherein the second volume comprises a capacity of about 0.5 percent to about 10 percent of a capacity of the first volume.

5. The vessel of claim 1, wherein the second volume comprises a capacity of about 1.0 percent to about 2.0 percent of a capacity of the first volume.

6. The vessel of claim 1, wherein the second volume forms a generally trough-like shape generally along a length of the one of the one or more sides.

7. The vessel of claim 1, wherein a spillway partially isolates the first volume and the second volume.

8. The vessel of claim 1, wherein the one of the one or more sides comprises a first height that is less than a second height of the other side.

9. The vessel of claim 1, wherein the vessel comprises a monolithic structure.

10. The vessel of claim 1, wherein the vessel comprises:
a first cross section having a generally U-shape; and
a second cross section oriented generally perpendicular to the first cross section and having:
a first generally vertical segment with a length, a first end and a second end;
a generally S-shape segment rotated about 90 degrees in a generally left direction with a first end connecting to the second end of the first generally vertical segment and a second end;
a second generally vertical segment with a length of about 2 to about 7 times the length of the first generally vertical segment, a first end connecting to the second end of the generally S-shape segment and a second end;
a first generally horizontal segment with a length of about 0.5 to about 5 times the length of the second generally vertical segment, a first end connecting to the second end of the second generally vertical segment and a second end; and
a third generally vertical segment with a length of greater than about the length of the second generally vertical segment and less than about the sum of the length of the first generally vertical segment and the length of the second generally vertical segment.

11. The vessel of claim 10, wherein a first radius of the generally S-shape segment comprises about 1 to about 5 times a second radius of the generally S-shape segment.

12. An apparatus for casting high purity silicon, the apparatus comprising:
a vessel having a first volume and a second volume, wherein the second volume fluidly connects with an upper portion of the first volume; and
a tipping mechanism for tipping the vessel.

13. The apparatus of claim 12, wherein the tipping mechanism raises or lowers one side of the apparatus.

14. The apparatus of claim 12, wherein the tipping mechanism displaces about 1 centimeter to about 10 centimeters.

15. The apparatus of claim 12, wherein the tipping mechanism displaces about 2.5 centimeters to about 5 centimeters.

16. The apparatus of claim 12, wherein the tipping mechanism comprises a hydraulic leg.

17. The apparatus of claim 12, wherein the tipping mechanism comprises a sloped surface.

18. A method for casting high purity silicon, the method comprising:
providing a feedstock in a first volume of a vessel;
solidifying at least a portion of the feedstock by extracting heat through a bottom or at least one side of the first volume; and
decanting a portion of the feedstock into a second volume.

19. The method of claim 18, wherein the decanting removes a top molten layer of feedstock with a higher concentration of impurities than a solidified portion of the feedstock.

20. The method of claim 18, wherein the decanting comprises transferring less than about 5 volume percent of the feedstock provided to the first volume to the second volume.

21. The method of claim 18, wherein the decanting comprises flowing the portion of the feedstock into the second volume based on expansion of the feedstock during solidification.

22. The method of claim 18, wherein the decanting comprises flowing a portion of the feedstock with actuation of a tipping mechanism.

23. The method of claim 18, further comprising melting the feedstock in the first volume.

24. A high purity silicon ingot made by the method of claim 18.

25. The ingot of claim 24, wherein the ingot comprises primarily silicon selected from the group consisting of multicrystalline silicon, monocrystalline silicon, near monocrystalline silicon, geometric multicrystalline silicon, and combinations thereof.

26. The ingot of claim 24, wherein the ingot is substantially free from radially distributed defects.

27. The ingot of claim 24, wherein the ingot comprises a carbon concentration of about 2×10¹⁶ atoms/centimeter cubed to about 5×10¹⁷ atoms/centimeter cubed, an oxygen concentration not exceeding 7×10¹⁷ atoms/centimeter cubed, and a nitrogen concentration of at least 1×10¹⁵ atoms/centimeter cubed.
